(19) United States
(12) Patent Application Publication
(10) Pub. No.: US 2008/0144799 A1
(43) Pub. Date: Jun. 19, 2008

(54) Module and Method for Automatically Detecting and Switching between FXO and FXS Interfaces via Single RJ11

(75) Inventors: Chieh Chang, Hsinchu (TW); Kenneth Wisheng Ouyang, Taipei City (TW); Yin-Kun Huang, Hsinchu (TW); Kuan-Hsi Chen, Hsinchu City (TW); Chih-Sheng Hsu, Kaohsiung City (TW)

Correspondence Address: WPAT, PC, 7225 BEVERLY ST., ANNANDALE, VA, 22003, US

(73) Assignee: F3 Inc., Hsinchu (TW)

(21) Appl. No.: 11/949,499

(22) Filed: Dec. 3, 2007

Related U.S. Application Data
(60) Provisional application No. 60/869,909, filed on Dec. 14, 2006.

(51) Int. Cl. H04M 3/00

(52) U.S. Cl. 379/243

(57) ABSTRACT

A module and method for automatically detecting and switching between FXO and FXS interfaces via a single RJ11 is disclosed. The module comprises a RJ11 jack, a USB controller, a modem element, a SLIC module and a DAA module, wherein the USB controller is electrically coupled with a computer for automatically detecting whether a PSTN phone line or a traditional telephone is plugged into the RJ11 jack. According to the detection, the telephone can be connected to the Internet for making and answering a VoIP call via the computer; the computer can be connected to the Internet for making and answering a VoIP call via the modem element; or the computer can make/answer a call to/from the PSTN.

### BACKGROUND OF THE INVENTION

1. Field of the Invention

The present invention generally relates to a module and method for automatically detecting and switching between FXO (Foreign exchange Office) and FXS (Foreign exchange Station) interfaces and, more particularly, a module and method for automatically detecting and switching between FXO and FXS interfaces via a single RJ11 jack.

2. Description of the Prior Art

Nowadays, modems are standard accessories for portable computers that are commercially available, but they are not used by consumers very often. However, in cases where no broadband network is available, modems are necessary for dialing up to the Internet.

Further, Analogue Telephone Adapters (ATA) and Internet callboxes currently on the market are essentially used to make VoIP calls or forward incoming calls to other telephone numbers. However, they play a critical role in VoIP technology and are essential when using a computer.

In the above descriptions, the connection interface is a single RJ11 jack. There is a need to integrate the abovementioned devices while maximizing their capabilities.

The RJ11 jack is the connection interface for a modem built in a portable computer for connecting to a line of a Public Switched Telephone Network (PSTN) to dial up to the Internet.

One of the current VoIP techniques uses the ATA to make a VoIP call, and its connection interface is a USB controller and a RJ11 jack. The USB controller is connected with a computer for sending/receiving voice data, while the RJ11 is connected to a traditional telephone via a telephone line for sending/receiving users' voices.

Another VoIP approach uses an Internet callbox to make a traditional or VoIP call, and its connection interface is a USB controller and two RJ11 jacks. One of the jacks is connected with a traditional telephone via a telephone line for sending/receiving users' voices, while the other one is connected with a PSTN line for making/receiving regular calls or diversion via the PSTN.

### SUMMARY OF THE INVENTION

In view of the prior art and the needs of the related industries, the present invention provides a module and method for automatically detecting and switching between FXO and FXS interfaces via a single RJ11 jack that solves the abovementioned shortcomings of the conventional.

One objective of the present invention is to provide a module and method for automatically detecting and switching between FXO and FXS interfaces via a single RJ11 jack. The module comprises a RJ11 jack, a USB controller, a modem element, a SLIC (Subscriber Line Interface Circuit) module and a DAA (Direct Access Arrangement) module, wherein the USB controller is electrically coupled with a computer for automatically determining whether a phone line of PSTN or a telephone is plugged into the RJ11 jack. According to the determination, the telephone can be connected to the Internet for making and answering a VoIP call via the computer; the computer can be connected to the Internet for making and answering a VoIP call via the modem element; or the computer can make/answer a call to/from a PSTN.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 is a schematic diagram of a structure for detecting a RJ11 jack.

FIGS. 2, 3 and 4 are schematic diagrams of a structure for realizing both VoIP phone and modem via a single RJ11;

FIGS. 5, 6, 7, 8 and 9 are schematic diagrams of a structure realizing an Internet callbox via a single RJ11;

FIGS. 10 and 11 are schematic diagrams of a structure that combines modem and Internet callbox functions; and

FIGS. 12, 13, 14 and 15 are schematic diagrams of structures according to another embodiment of the present invention.

### DETAILED DESCRIPTION OF THE PREFERRED EMBODIMENTS

The present invention is directed to a module and method for automatically detecting and switching between FXO and FXS interfaces via a single RJ11 jack. Detailed steps and constituents are given below to assist in the understanding the present invention. Obviously, the implementations of the present invention are not limited to the specific details known by those skilled in the art. On the other hand, well-known steps or constituents are not described in details in order not to unnecessarily limit the present invention. Detailed embodiments of the present invention will be provided as follow. However, apart from these detailed descriptions, the present invention may be generally applied to other embodiments, and the scope of the present invention is thus limited only by the appended claims.

An embodiment of the present invention is a module 100 for automatically detecting and switching between FXO and FXS interfaces via a single RJ11 jack. The module 100 includes a USB controller 110, a RJ11 jack 112, a detecting module 114 and a modem element 116. The USB controller 110 is electrically coupled with a computer 130. The RJ11 jack 112 is connected to one of a PSTN 118 and a telephone 120. The detecting module 114 detects different characteristics of the electrically signals of the RJ11 jack, so as to determine whether the RJ11 jack 112 is connected to the PSTN 118 or the telephone 120. The method of detection is as follows:

Detection Based on Voltage Characteristics:

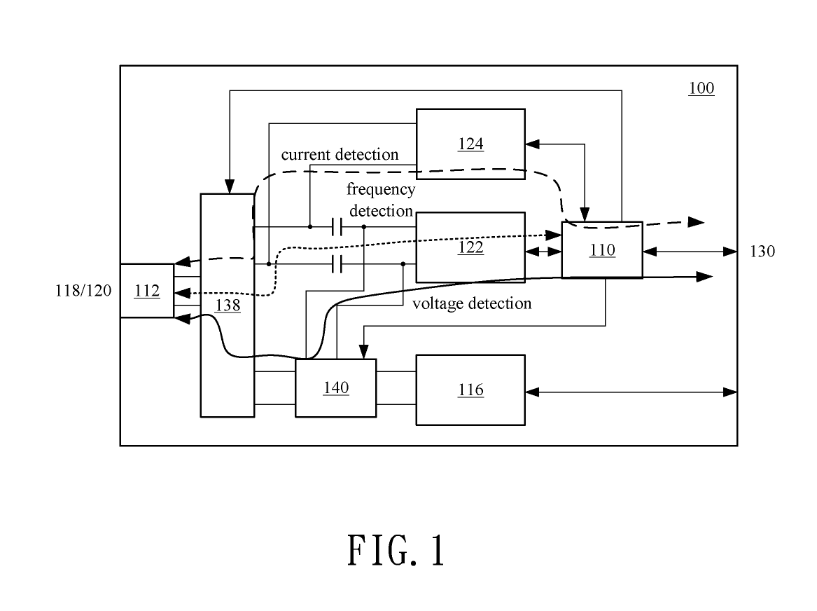

Generally, the PSTN 118 provides 48V. Referring to FIG. 1, a SLIC (Subscriber Line Interface Circuit) module 122 of the detecting module 114 detects whether a voltage is present at RJ11 jack 112, if the voltage exceeds a predetermined value (e.g. set to 18V), then the RJ11 jack 112 is connected to the PSTN 118; else if the voltage is smaller than the predetermined value, then the RJ11 jack 112 is connected to the telephone 120.

Detection Based on Current Characteristics:

A DAA (Direct Access Arrangement) module 124 of the detecting module 114 emulates an “off-hook” situation to detect whether a current is present at the RJ11 jack. When DAA module 124 emulates “off-hook” and current flows through the DAA module 124, then the RJ11 jack is connected to the PSTN 118, since the DAA module 124 forms an current loop with the PSTN 118 where current flows. On the contrary, if no current flow through the DAA module 124, then the RJ11 jack 112 is connected to the telephone.

Detection Based on Signal Frequency:

In this scenario, a DSP (Digital Signal Processor) of the computer 130 detects whether the RJ11 jack 112 has an audio frequency. When the DAA module 124 emulates “off-hook”, the computer 130 detects whether the electrical signal of the RJ11 jack 112 is a dial tone via a set of capacitors 126, the SLIC module 122 and the USB controller 110. If the computer 130 detects a dial tone, then the RJ11 jack 112 is connected to the PSTN 118, since a current loop is formed between the DAA module 124 and the PSTN 118, where a dial tone can be sent from the PSTN 118. On the contrary, if the computer 130 detects no dial tone, then the RJ11 jack is connected with the telephone 120. The DSP software can be substituted with equivalent hardware circuit elements that are well-know to those skilled in the art and will not be described further.

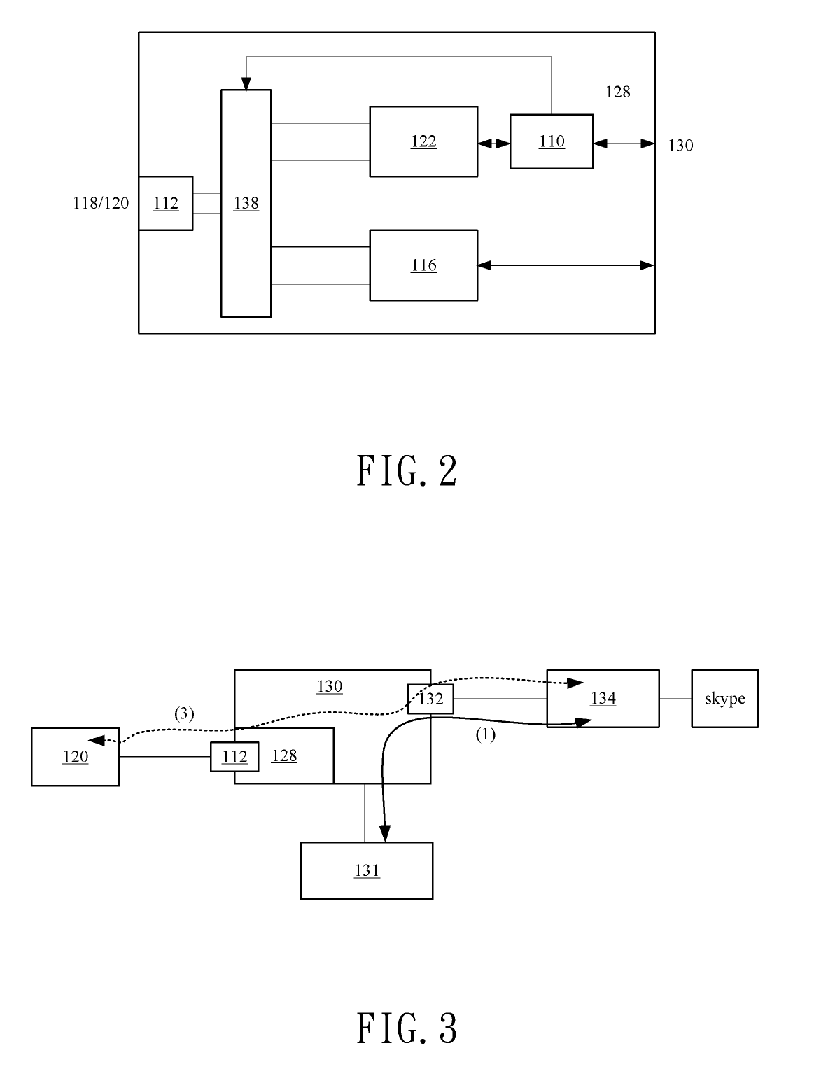

FIG. 2 is a schematic diagram of a module 128 that realizes both a VoIP phone and a modem via a single RJ11 jack. The abovementioned computer 130 can be a notebook computer. Based on the detection methods above, it can be known that to which one the RJ11 jack 112 is connected. When the above module 128 is used in cooperation with the computer 130, a variety of applications is possible, examples of which are given below:

RJ11 Jack 112 Connecting to Telephone 120:

As shown in FIG. 3, path (1) allows earpieces and a microphone 131 of the computer 130 to make/receive Skype VoIP phone calls; and path (3) allows telephone 120 to make/receive Skype phone calls, wherein the computer 130 is connected to an IP network 134 via a RJ45 jack 132.

RJ11 Jack 112 Connecting to PSTN 118:

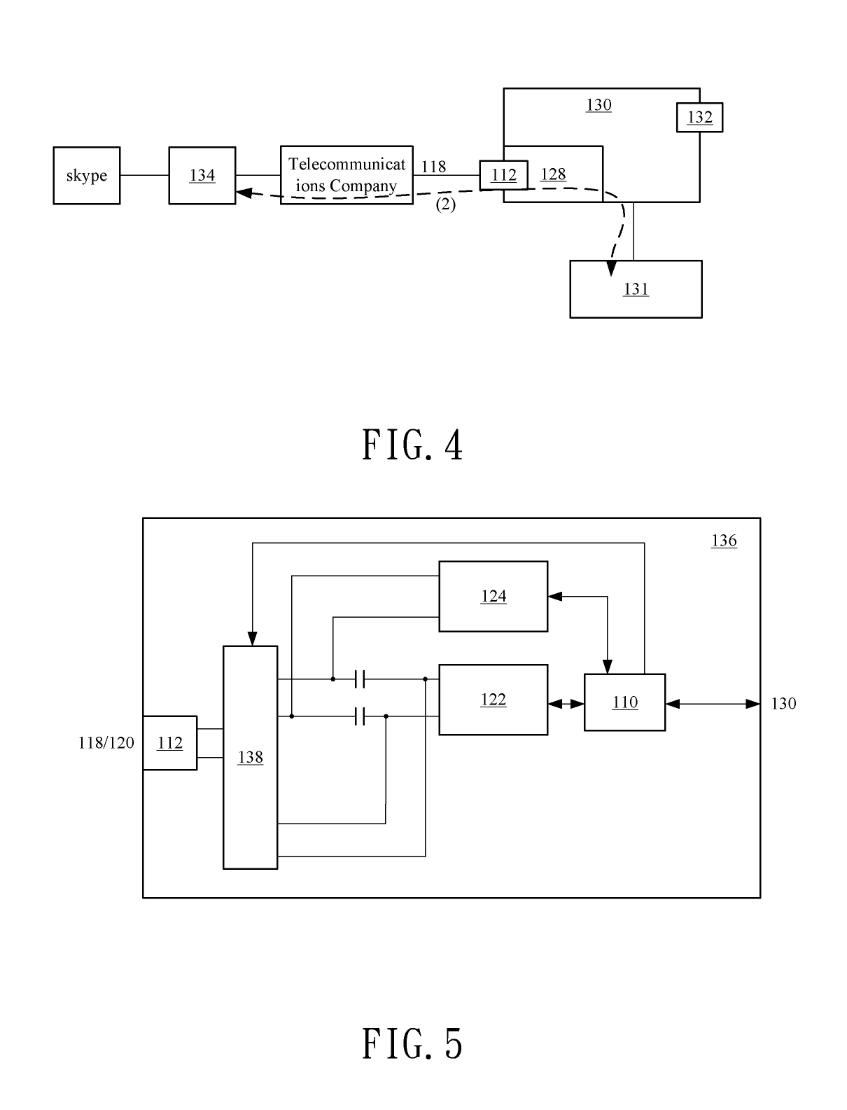

As shown in FIG. 4, path (2) allows the modem element 116 to connect to the Internet via dial up and the earpieces and microphone 131 of the computer to make/receive Skype calls.

FIG. 5 shows a schematic diagram of the module 136 that realizes an Internet callbox via a single RJ11. Based on the detection methods above, it can be known that to which one of the traditional phone and the PSTN line the RJ11 jack 112 is connected. When the module 136 is used in cooperation with the computer 130, a variety of applications is possible, examples of which are given below:

RJ45 Jack 132 Connected to IP Network 134:

a. RJ11 Jack 112 Connecting to PSTN 118:

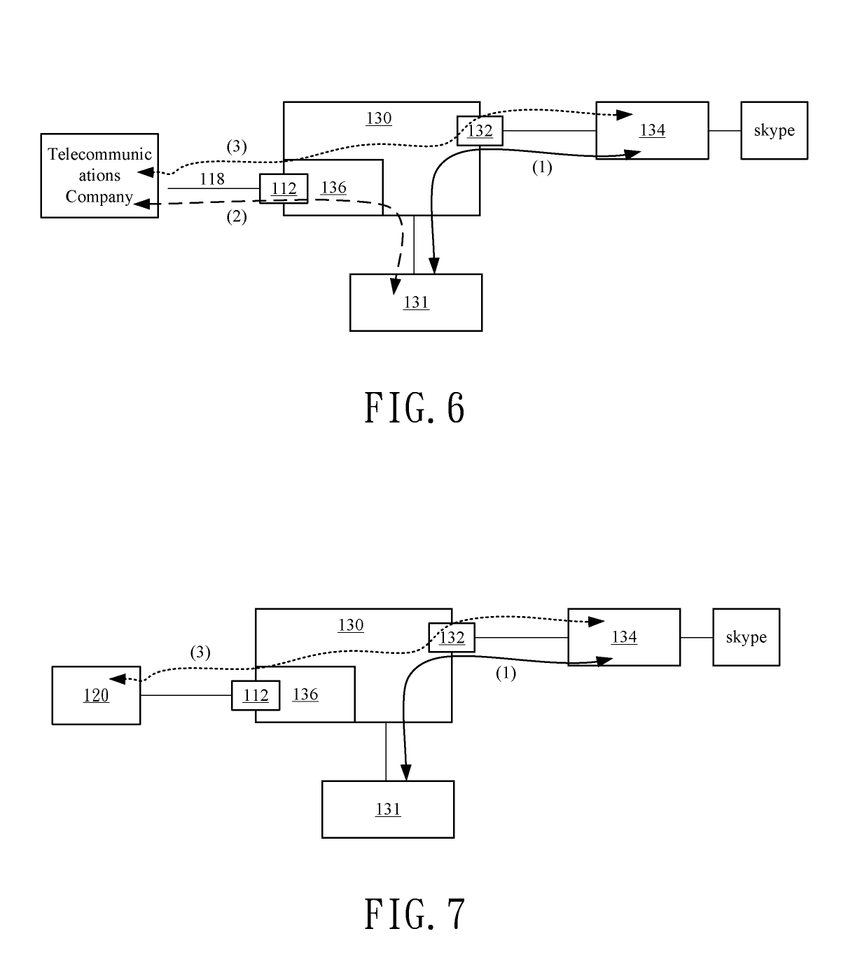

As shown in FIG. 6, path (1) allows the earpieces and microphone 131 of the computer 130 to make/receive Skype calls; path (2) allows the earpieces and microphone 131 of the computer 130 to receive calls from PSTN 118; and path (3) allows diversion of Skype calls to PSTN 118 or diversion of calls from PSTN 118 to Skype.

b. RJ11 Jack 112 Connecting to Telephone 120:

As shown in FIG. 7, path (1) allows the earpieces and microphone 131 of the computer 130 to make/receive Skype calls; and path (3) allows the telephone 120 to make/receive Skype calls.

RJ11 Jack 112 Not Connected to IP network 134:

a. RJ11 Jack 112 Connecting to PSTN 118:

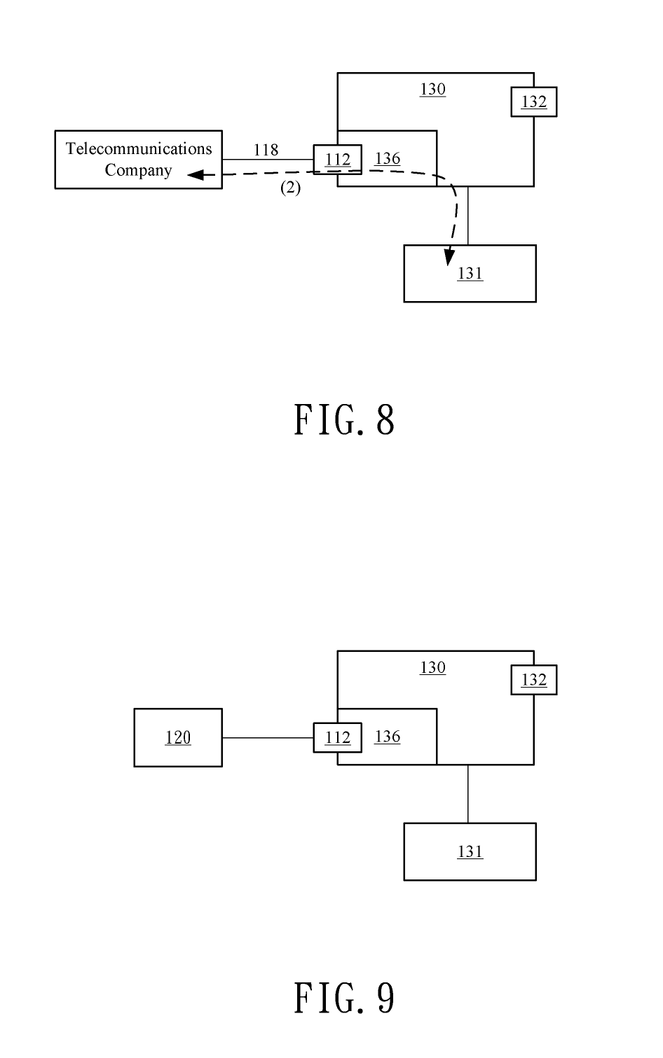

As shown in FIG. 8, path (2) allows the earpieces and microphone 131 of the computer 130 to receive calls from PSTN 118.

b. RJ11 Jack 112 Connecting to Telephone 120:

As shown in FIG. 9, the telephone 120 and the earpieces and microphone 131 of the computer 130 are connected via the computer 130, thereby achieving local extensions.

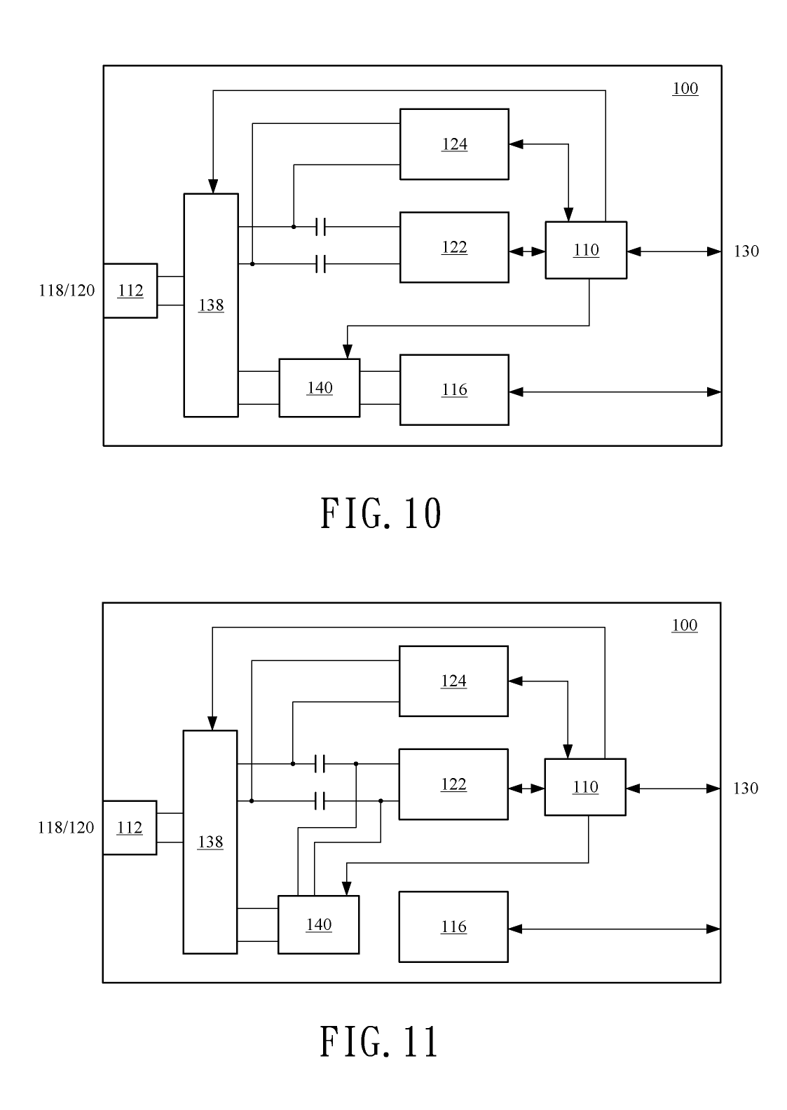

Furthermore, the above module 100 may further include a first relay 138 and a second relay 140, wherein the USB controller 110, the SLIC module 122 and the DAA module 124 establish communication through the first relay 138 and the RJ11 jack 112; while the USB controller 110, the modem element 116 and the SLIC module 122 is electrically coupled to the first relay 138 via the second relay 140. The second relay 140 may select modem or Internet callbox functionality. Referring to FIG. 10, when the second relay 140 selects modem functionality, the above module 100 performs the path (2) of FIG. 4. Referring to FIG. 11, when the second relay 140 selects Internet callbox functionality, the applications of the above module 100 can include all those paths shown in FIGS. 6 to 9.

The above embodiments include the following cases:

A. RJ11 jack connected to PSTN 118 and computer connected to IP network 134;

B. RJ11 jack connected to PSTN 118 and computer not connected to IP network 134;

C. RJ11 jack connected to telephone 120 and computer connected to IP network 134;

D. RJ11 jack connected to telephone 120 and computer not connected to IP network 134;

When the result of detection is case A, as shown in FIG. 6, the applications of the module 100 for automatically detecting and switching between FXO and FXS interfaces via a single RJ11 jack include:

Path (1): a communication link is established between the computer 130 and the IP network 134 (e.g. the computer 130 makes/receives a VoIP call from the IP network 134);

Path (2): a communication link is established between the PSTN 130 and the computer 130 (e.g. the computer 130 receives a call from the PSTN 118);

Path (3): a communication link is established between the IP network 134 and the PSTN 118 via the computer 130 (e.g. the computer 130 forwards a VoIP call from the IP network 134 to the PSTN 118, or the computer 130 forwards a call from the PSTN 118 to the IP network 134).

When the result of detection is case B, as shown in FIG. 4, the applications of the above module 100 include:

Path (2): a communication link is established between the PSTN 118 and the computer 130 (e.g. the computer 130 receives a call from the PSTN 118). Alternatively, if the modem element 116 is connected to the IP network 134 via dial up through the PSTN 118, a communication link can be established between the computer 130 and the IP network 134 (e.g. the modem element 116 is connected to the IP network 134 via dial up through the PSTN 118 and the computer makes/receives a VoIP call via the IP network 134).

When the result of detection is case C, as shown in FIG. 7, the applications of the above module 100 include:

Path (1): a communication link is established between the computer 130 and the IP network 134 (e.g. the computer 130 makes/receives a VoIP call from the IP network 134);

Path (3): a communication link is established between the IP network 134 and the telephone 120 (e.g. the telephone 120 makes/receives a VoIP phone from the IP network 134).

When the result of detection is case D, as shown in FIG. 9, the application of the above module 100 include:

A communication link is established between the computer 130 and the telephone 120 (e.g. the telephone and the earpieces and microphone of the computer 130 form local extension lines).

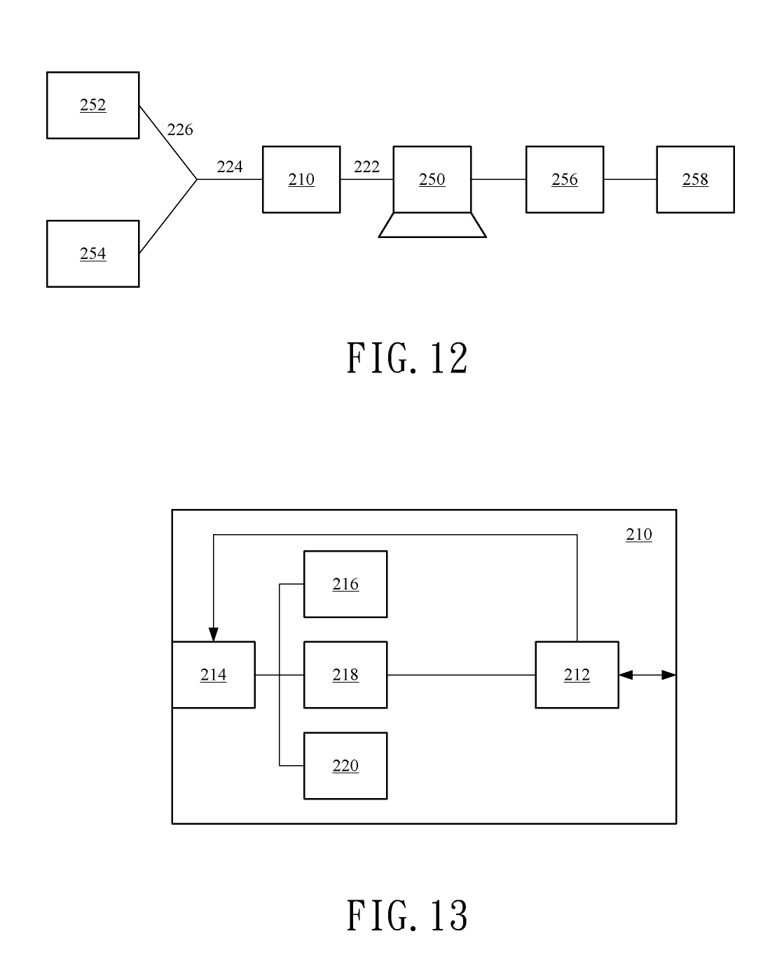

According to the above, the present invention may further provide a system 200 for automatically detecting and switching between FXO and FXS interfaces via a single RJ11 jack. Referring to FIG. 12, the system 200 includes a communication interface extension module 210, a computer 250, a first remote communication device 252, a communication device 254, a network communication device 256 and a second remote communication device 258. As shown in FIG. 13, the communication interface extension module 210 includes a first communication element 212, a RJ11 jack 214, a second communication element 216, a communication control element 218 and a detecting module 220.

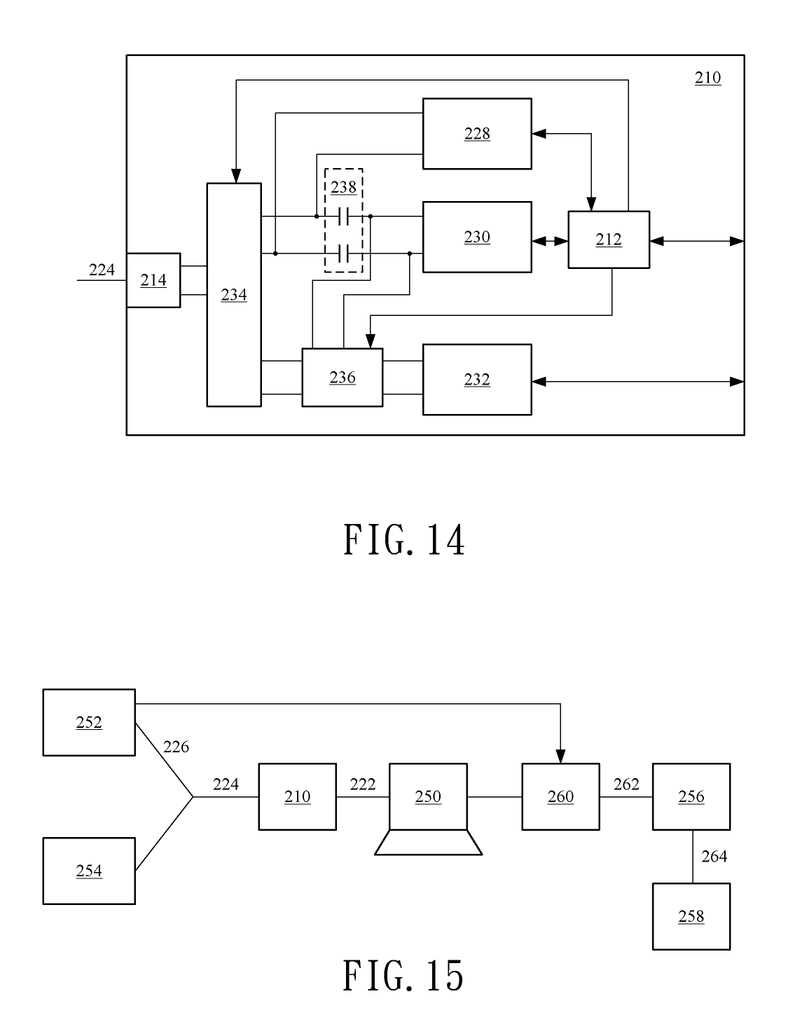

As shown in FIG. 12, a first communication link 222 may be established between the first communication element 212 and the computer 250. A second communication link 224 may be established by the second communication element 216 via the RJ11 jack 214. When the RJ11 jack is connected to a PSTN 226, the second communication element 216 establishes the second communication link 224 with the first remote communication device 252. When the RJ11 jack 214 is connected to the communication device 254, the second communication element 216 establishes the second communication link 224 with the communication device 254. The first communication element 212 can be a USB controller module, a Bluetooth module, an Infrared module, a radio wave transmitting module or other equivalent modules. The second communication element 216 can be one or a combination of the following group: a DAA module 228, a SLIC module 230 and a modem element 232. The second communication element 216 may further include a first relay 234 and a second relay 236, wherein the first communication element 212, the DAA module 228 and the SLIC module 230 establishes the second communication link 224 via the RJ11 jack 214 and the first relay 234; and the first communication element 212, the modem element 232 and the SLIC module 230 electrically couples to the first relay 234 via the second relay 236, as shown in FIG. 14. Moreover, the first remote communication device 252 can be an exchange unit of PSTN, and the communication device 254 can be a telephone.

The communication control element 218 allows a user interface of the computer 250 to be formed from one of the first remote communication device 252 and the communication device 254 by controlling the first and second communication links 222 and 224. For example, if the telephone is used as a user interface of the computer 250, then one can make a VoIP call via the computer 250. Alternatively, if an exchange unit of the PSTN is used as a user interface of the computer 250, then the computer 250 can receive calls from the PSTN 224. The computer 250 controls the communication control element 218 via the first communication link 222, and the computer 250 is connected to an IP network 260, wherein the computer may exchange data via the IP protocol through a VoIP/VoIM communication protocol. The communication control element 218 can be one or a combination of the DAA module 228 and the SLIC module 230.

The detecting module 220 detects whether the RJ11 jack 214 is connected to the PSTN 226, and creates a detection result. Based on this result, the communication control element 218 selects one of the first remote communication device 252 and the communication device 254 as the user interface of the computer 250. The detection module 220 may include a set of capacitors 238, the DAA module 228 and the SLIC module 230 to detect an electrical signal from the second communication link 224. The electrical signal may include a dial tone, a current and a voltage. The set of capacitors 238 are two capacitors in parallel. When the DAA 228 emulates an off-hook situation, the computer 250 may detect whether a dial tone is coming from the second communication link 224 via the set of capacitors 238, the SLIC module 230 and the first communication element 212. If the computer 250 detects a dial tone from the second communication link 224 via the set of capacitors 238, the RJ11 jack 214 is connected to the PSTN 226; else if there is no dial tone from the second communication link 224, the RJ11 jack 214 is connected to the communication device 254.

Furthermore, When the DAA 228 emulates an off-hook situation, the computer 250 may detect whether a current is coming from the second communication link 224. If the DAA module 228 detects a current from the second communication link 224, the RJ11 jack 214 is connected to the PSTN 226; else if the DAA module 228 detects no current from the second communication link 224, the RJ11 jack 214 is connected to the communication device 254.

The SLIC module 230 may detect whether a voltage of the second communication link 224 is greater than a predetermined value. When the voltage is larger than the predetermined value, the RJ11 jack 214 is connected to the PSTN 226; else if the voltage is smaller than the predetermined value, the RJ11 jack 214 is connected to the communication device 254.

Referring to FIG. 15, the modem element 232 is connected to the IP network 260 via the first remote communication device 252, that is, the modem element 232 is connected to the Internet via an exchange unit of the PSTN 226 through dial up. The modem element 232 may be built in the computer 250 which can be a notebook computer, for example.

The first remote communication device 252 makes a call to the second communication element 216 via the PSTN 226 to establish the second communication link 224. For example, a PSTN exchange unit makes a call to the second communication element 216 via the PSTN 226 to establish the second communication link 224. On the other hand, the second communication element 216 can make a call to the first remote communication device 252 via the PSTN 226 to establish the second communication link 224. For example, the second communication element 216 can make a call to the PSTN exchange unit via the PSTN 226 to establish the second communication link 224.

The computer 250 can establish a third communication link 262 with the network communication device 256 via the IP network 260. The computer 250 uses the third communication link 262 to exchange multimedia data. The network communication device 256 may be a remote computer. For example, the computer 250 establishes a Skype phone call with the remote computer via the IP network 260. Thus, the network communication device 256 may be one or a combination of a remote computer and a VoIP phone device. The VoIP phone device can be earpieces and a microphone, for example.

The user interface exchanges multimedia data with the network communication device 256 via the computer 250. The network communication device 256 may establish a fourth communication link 264 with a second remote communication device 258 via the PSTN 226. The computer 250 exchanges multimedia data with the second remote communication device 258 through the fourth communication link 264. The second remote communication device 258 may be one or a combination of a remote telephone and a PSTN exchange unit. The user interface exchanges multimedia data with the second remote communication device 258 via the computer 250. For example, a PSTN exchange unit or a telephone establishes VoIP communication with a remote computer through the computer 250, or a PSTN exchange unit or a telephone establishes communication through the computer 250 with a remote telephone via the PSTN 226.

The computer 250 may receive a first control command via the third communication link 262 and, based on the first control command, controls the communication control element 218 to request the second communication element 216 makes a call to the first remote communication device 252 via the PSTN 226, so as to establish the second communication link 224. For example, a remote computer makes a VoIP phone call to the computer 250, and transmits the first control command to the computer 250 to request the computer 250 to control the communication control element 218, which enables the second communication element 216 to forward the VoIP phone call via the PSTN 226.

On the other hand, the computer 250 may receive a second control command via the user interface and, based on the second control command, establish the third communication link 262. For example, the computer 250 receives a call from a PSTN exchange unit or telephone, and forwards the call to a remote computer based on the second control command in the phone call. Similarly, the computer 250 may request the network communication device 256 to establish the fourth communication link 264 based on the second control command. That is, the computer 250 requests the remote computer to further forward the call to another PSTN exchange unit or another remote telephone.

According to the above embodiments, the present invention further provides a method for extending communication interface, including the following steps of:

establishing a first communication link with a computer by a first communication element;

establishing a second communication link via the RJ11 jack by a second communication element, wherein when the RJ11 jack is connected to a public switched telephone network (PSTN), the second communication element establishes the second communication link with a remote communication device via the PSTN, and when the RJ11 jack is connected to a communication device, the second communication element establishes the second communication link with the communication device;

detecting whether the RJ11 jack is connected to the PSTN and generating a detection result, and controlling the first communication link and the second communication link based on the detection result to select one of the remote communication device and the communication device as a user interface of the computer.

Furthermore, the method for extending communication interface further includes the following steps of:

connecting to a IP network via the remote communication device by the modem element, wherein the modem element is built in the computer, wherein the computer is a notebook computer.

The above remote communication device makes a call to the second communication element via the PSTN to establish the second communication link, or the above second communication element makes a call to the remote communication device via the PSTN to establish the second communication link.

Another embodiment of the present invention provides a method for automatically detecting and switching between FXO and FXS interfaces via a single RJ11 jack, including the following steps of:

establishing a first communication link with a computer by a first communication element;

establishing a second communication link via the RJ11 jack by a second communication element, wherein when the RJ11 jack is connected to a public switched telephone network (PSTN), the second communication element establishes the second communication link with a first remote communication device via the PSTN, and when the RJ11 jack is connected to a communication device, the second communication element establishes the second communication link with the communication device;

detecting whether the RJ11 jack is connected to the PSTN and generating a detection result and, based on the detection result, selecting one of the first remote communication device and the communication device as a user interface of the computer;

controlling the first and second communication links to select one of the first remote communication device and the communication device as the user interface of the computer; and

controlling the communication control element via the first communication link by the computer, wherein the computer exchanges a multimedia data via the IP network through a VoIP/VoIM communication protocol.

Furthermore, the method for automatically detecting and switching between FXO and FXS interfaces via a single RJ11 jack further includes the following steps of:

connecting to a IP network via the first remote communication device by the modem element, wherein the modem element is built in the computer, wherein the computer is a notebook computer.

The above first remote communication device makes a call to the second communication element via the PSTN to establish the second communication link, or the above second communication element makes a call to the first remote communication device via the PSTN to establish the second communication link.

The above computer establishes a third communication link with a network communication device via the IP network, the computer exchanging the multimedia data via the third communication link, wherein the user interface exchanging the multimedia data with the network communication device via the computer, wherein the network communication device is one or a combination of a remote computer and a voice-over-IP (VoIP) device.

Moreover, the above network communication device establishes a fourth communication link with a second remote communication device via the PSTN, wherein the user interface exchanging the multimedia data with the second remote communication device via the computer, the second remote communication device being one or a combination of a PSTN exchange unit and a telephone.

The above computer may receive a first control command via the third communication link and, based on the first control command, control the communication control element to request the second communication element to make a call to the first remote communication device via the PSTN, thereby establishing the second communication link. Similarly, the above computer may receive a second control command via the user interface and establish the third communication link based on the second control command, or the above computer requests the network communication device to establish the fourth communication link based on the second control command.

The detection result is generated by a DAA module detecting an electrical signal from the second communication link, wherein when the DAA module emulates an off-hook status, the computer detecting whether a dial tone is coming from the second communication link via the set of capacitors, the SLIC module and the first communication element, if the computer detecting a dial tone from the second communication link via the set of capacitors, the RJ11 jack being connected to the PSTN; else if there is no dial tone from the second communication link via the set of capacitors, the RJ11 jack being connected to the communication device, wherein the set of capacitors are two capacitors in parallel.

The above electrical signal further includes a current, wherein when the DAA module emulates an off-hook status, the computer detecting whether a current is coming from the second communication link, if the DAA module detecting a current from the second communication link, the RJ11 jack being connected to the PSTN; else if the DAA module detecting no current from the second communication link, the RJ11 jack being connected to the communication device.

The above electrical signal further includes a voltage, a SLIC module detects whether a voltage at the second communication link is greater than a predetermined value. If the voltage is greater than the predetermined value, the RJ11 jack is connected to the PSTN; else if the voltage is smaller than the predetermined value, the RJ11 jack is connected to the communication device.

The above first remote communication device can be a PSTN exchange unit. The above second remote communication device can be one or a combination of a telephone and a PSTN exchange unit. The above communication device can be a telephone. The above first communication element can be one or a combination of a serial port, a parallel port, a universal serial bus (USB) controller, a Bluetooth module, an infrared transmitting module and a radio wave transmitting module or any other devices that have equivalent functionalities. The above second communication element is one or a combination of a SLIC module, a DAA module and a modem element.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

1. A system for automatically detecting and switching between foreign exchange office (FXO) and foreign exchange station (FXS) interfaces via a single RJ11 jack, including:
a communication interface extension module, including:
a first communication element for establishing a first communication link with a computer;
a RJ11 jack;
a second communication element for establishing a second communication link via the RJ11 jack, wherein
when the RJ11 jack is connected to a public switched telephone network (PSTN), the second communication element establishes the second communication link with a first remote communication device via the PSTN, and
when the RJ11 jack is connected to a communication device, the second communication element establishes the second communication link with the communication device;
a communication control element forming a user interface of the computer from one of the first remote communication device and the communication device by controlling the first and second communication links; and
the computer for controlling the communication control element via the first communication link and the computer being connected to an Internet Protocol (IP) network, wherein the computer exchanges a multimedia data via the IP network through a VoIP/VoIM communication protocol.

2. A system of claim 1, wherein the communication interface extension module further includes a detecting module for detecting whether the RJ11 jack is connected to the PSTN and generating a detection result, wherein the communication control element selects one of the first remote communication device and the communication device as the user interface of the computer based on the detection result.

3. A system of claim 2, wherein the detecting module includes a direct access arrangement (DAA) module, a subscriber line interface circuit (SLIC) module and a set of capacitors, the DAA module detecting an electrical signal from the second communication link, wherein the electrical signal includes a dial tone and a current, the detecting module including the following situations:
when the DAA module emulating an off-hook status, the computer detecting whether a dial tone is coming from the second communication link via the set of capacitors, the SLIC module and the first communication element, if the computer detecting a dial tone from the second communication link via the set of capacitors, the RJ11 jack being connected to the PSTN; else if there is no dial tone from the second communication link via the set of capacitors, the RJ11 jack being connected to the communication device, wherein the set of capacitors are two capacitors in parallel; and
when the DAA module emulating an off-hook status, the computer detecting whether a current is coming from the second communication link, if the DAA module detecting a current from the second communication link, the RJ11 jack being connected to the PSTN; else if the DAA module detecting no current from the second communication link, the RJ11 jack being connected to the communication device.

4. A system of claim 2, wherein the detecting module includes a SLIC module for detecting whether a voltage at the second communication link is greater than a predetermined value, if the voltage being greater than the predetermined value, the RJ11 jack being connected to the PSTN; else if the voltage being smaller than the predetermined value, the RJ11 jack being connected to the communication device.

5. A system of claim 1, wherein the communication interface extension module further includes a modem element, which connects to the IP network via the first remote communication device, wherein the modem element is built in the computer.

6. A system of claim 5, wherein the establishing of the second communication link includes:
the first remote communication device making a call to the second communication element via the PSTN to establish the second communication link; and
the second communication element making a call to the first remote communication device via the PSTN to establish the second communication link.

7. A system of claim 1, wherein the exchange of the multimedia data includes:
the computer establishing a third communication link with a network communication device via the IP network, the computer exchanging the multimedia data via the third communication link, wherein the network communication device is one or a combination of a remote computer and a voice-over-IP (VoIP) device; and
the network communication device establishing a fourth communication link with a second remote communication device via the PSTN, the computer exchanging the multimedia data with the second remote communication device via the third and fourth communication links.

8. A system of claim 7, wherein the exchange of the multimedia data includes:
the user interface exchanging the multimedia data with the network communication device via the computer;
the user interface exchanging the multimedia data with the second remote communication device via the computer, the second remote communication device being one or a combination of a remote telephone and a PSTN exchange unit; and
the computer receiving a first control command via the third communication link and, based on the first control command, controlling the communication control element to request the second communication element to make a call to the first remote communication device via the PSTN, thereby establishing the second communication link.

9. A system of claim 7, wherein the computer receives a second control command via the user interface and establishes the third communication link based on the second control command.

10. A system of claim 9, wherein, based on the second control command, the computer requests the network communication device to establish the fourth communication link.

11. A system of claim 1, wherein the first remote communication device is a PSTN exchange unit,
wherein the communication device is a telephone; the first communication element is one or a combination of a serial port, a parallel port, a universal serial bus (USB) controller, a Bluetooth module, an infrared transmitting module and a radio wave transmitting module,
wherein the second communication element is one or a combination of a SLIC module, a DAA module and a modem element,
wherein the communication control element is one or a combination of a SLIC module and a DAA module.

12. A system of claim 1, wherein the second communication element further includes:
a first relay, the first communication element, the SLIC module and the DAA module establishing the second communication link via the first relay and the RJ11 jack; and
a second relay, the first communication element, the modem element and the SLIC module electrically coupling to the first relay via the second relay.
